(19) United States
(12) Patent Application Publication
(10) Pub. No.: US 2025/0261671 A1
(43) Pub. Date: Aug. 21, 2025

(54) COMPOSITION FOR MAKING BOUILLONS

(71) Applicant: Conopco, Inc., d/b/a UNILEVER, Englewood Cliffs, NJ (US)

(72) Inventors: Livia CEBOTARESCU, Wageningen (NL); Marcelo CAMILO DE OLIVEIRA, Wageningen (NL); Harmannus TAMMES, Wageningen (NL)

(73) Assignee: Conopco, Inc., d/b/a UNILEVER, Englewood Cliffs, NJ (US)

(21) Appl. No.: 18/254,198

(22) PCT Filed: Dec. 20, 2021
(86) PCT No.: PCT/EP2021/086759

§ 371 Date: May 24, 2023

(30) Foreign Application Priority Data
Dec. 30, 2020 (EP) 20217753.1

(51) Int. Cl. A23L 23/10; A23P 30/20

(52) U.S. Cl. CPC A23L 23/10; A23P 30/20

(57) ABSTRACT

The objective of the current invention is to provide a composition that can be used for making bouillons, soups and gravies, and that is substantially free from kitchen salt.

### FIELD OF THE INVENTION

The present invention relates to a composition that can be used for making ready-to-eat bouillons with hardly any salt. The invention also relates to a method for preparation of such compositions.

### BACKGROUND TO THE INVENTION

Bouillon tablets are well known compositions for conveniently preparing a ready-to-eat bouillon. Bouillon tablets are also described as bouillon cubes and are solid tablets often of about 10 gram. The directions of use on the packaging of a bouillon tablet are usually to add one tablet of 10 gram to 500 g of hot water or dish. For example, a recipe for preparing a beef stew may include the step of adding one beef bouillon tablet to 500 g of beef stew to bring out the savoury and beef flavour.

There are two main types of bouillon tablets: on the one hand so called pressed tablets and on the other hand pasty tablets. Each requires a different processing technology. Pressed tablets are normally made by pressing a free-flowing bouillon powder into the desired rectangular mould. Pasty tablets are made from a pasty bouillon mass which is pushed through a nozzle into a mould. The different technical features of a free-flowing powder versus a pasty bouillon mass, results in different processing equipment. To push pasty bouillon mass trough the dosing nozzle a much higher pressure is needed compared to dosing a free-flowing bouillon powder. Obviously, these different technologies impose different technical characteristics regarding the respective composition and ingredients used.

Pasty tablets are shape retaining but remain plastic deformable. It is relatively easy to make an indent by pushing a finger into a pasty tablet. In contrast, a pressed tablet is rather brittle and made by compressing free flowing powder with considerable force. The result is a hard tablet which will not deform plastically but will rather break.

Essential ingredients of standard bouillon tablets are kitchen salt crystals and monosodium glutamate crystals. Historically, standard bouillon tablets contain 40-60 wt % of NaCl. Consumers expect this and often use bouillon tablets as a cooking aid to partially or completely replace addition of NaCl. The manufacturing process of both pressed and pasty tablets is completely adapted to such high amounts of crystalline NaCl and monosodium glutamate (MSG) particles. In pressed tablets, NaCl contributes to the free-flowing behaviour.

While with pasty tablets, the high amount of NaCl crystals helps to achieve the right consistency of the pasty composition such that it can be easily processed and dosed.

However, there is a desire among consumers to reduce their salt intake, and in particular sodium intake, because of health concerns that consumers may have associated with excessive consumption of salt.

U.S. Pat. No. 5,232,732 describes a dry soup mix adopted to be combined with water and residual food items in field ration tray packs to provide a soup, the mix having a salt content of not greater than 6%.

Information about a salt-free vegetable stock cube that was marketed in Brazil can be retrieved from DATABASE GNPD [Online], MINTEL; 17 Aug. 2020, “Vegetable Stock Cubes”, XP055814369, Database accession no. 80311535. This product contained vegetable fat, sugar, herbs, spices and vegetables, starches and dextrins, and maltodextrin.

Information about a salt-free meat stock cube from that was also marketed in Brazil can be obtained from DATABASE GNDP [online], MINTEL; 27 Jul. 2020, anonymous: “Meat Stock Cubes”, XP055814371, Database accession no. 7979873. This product contained vegetable fat, sugar, herbs, spices and vegetables, starches and dextrins and maltodextrin.

To avoid having to build new bouillon tablet production lines it is desirable to produce bouillon tablets without the usual amount of NaCl and MSG crystals on existing production lines.

We have now found that omitting the large amount of crystalline NaCl and MSG normally present in bouillon tablets may lead to processing issues using standard processing equipment for producing bouillon tablets. A number of issues including increased fouling and/or problems with dosing may lead to undesirably low production line efficiencies These issues may result in increased down time due to extra cleaning and other issues with dosing.

### SUMMARY OF THE INVENTION

We have now developed a composition for a bouillon tablet designed for preparing a ready-to-eat bouillon, having less than 0.75 wt % of sodium and which provides unexpected advantages, including improved production line efficiencies, dissolution.

The present invention provides a composition for making bouillons, comprising by weight of the total composition:
a) 0 to 10 wt % of vegetable oil;
b) 0 to 25 wt % of crystalline mono- and/or disaccharides;
c) 0.5 to 30 wt % of herbs, spices and vegetables;
d) 0 to 30 wt %, preferably 0 to 15 wt % of native ungelatinised starch;
e) 15 to 50 wt % preferably 20 to 50 wt % of glassy carbohydrate material;
f) 5 to 40 wt % of fat, preferably 10 to 40 wt %, more preferably 20 to 35 wt %, even more preferably 22 to 30%;
g) 0 to 0.75 wt % of Na+;
and wherein the weight/weight ratio between starch and the glassy carbohydrate material is from 0 to 0.5, preferably from 0 to 0.4, more preferably from 0 to 0.3, more preferably from 0 to 0.29, even more preferably from 0 to 0.27.

The present invention provides a composition for making bouillons, comprising by weight of the total composition:
a) 0 to 10 wt % of vegetable oil;
b) 0 to 25 wt % of crystalline mono- and/or disaccharides;
c) 0.5 to 30 wt % of herbs, spices and vegetables;
d) 0 to 30 wt %, preferably 0 to 15 wt % of native ungelatinised starch;
e) 15 to 50 wt % preferably 20 to 50 wt % of dry glucose syrup, maltodextrin, polydextrose and mixtures thereof;
f) 5 to 40 wt % of fat, preferably 10 to 40 wt %, more preferably 20 to 35 wt %, even more preferably 22 to 30%;
g) 0 to 0.75 wt % of Na+;
and wherein the weight/weight ratio between
   Starch; and
   dry glucose syrup, maltodextrin, polydextrose and mixtures thereof
is from 0 to 0.5, preferably from 0 to 0.4, more preferably from 0 to 0.3, more preferably from 0 to 0.29, even more preferably from 0 to 0.27.

The invention also provides a method for the preparation of a composition for making bouillons according to the invention, comprising the steps of:
i. Mixing 50-100% of the ingredients of the composition except for the fat;
ii. Admixing the fat, preferably in the form of solid fat;
iii. Optionally admixing the remainder of the ingredients if any
iv. Dosing the composition into portions, preferably in portions of 2-30 gram per portion.

Said composition comprising by weight of the total composition:
a) 0 to 10 wt % of vegetable oil;
b) 0 to 25 wt % of crystalline mono- and/or disaccharides;
c) 0.5 to 30 wt % of herbs, spices and vegetables;
d) 0 to 30 wt %, preferably 0 to 15 wt % of native ungelatinised starch;
e) 15 to 50 wt % preferably 20 to 50 wt % of glassy carbohydrate material;
f) 5 to 40 wt % of fat, preferably 10 to 40 wt %, more preferably 20 to 35 wt %, even more preferably 22 to 30%;
g) 0 to 0.75 wt % of Na+;
and wherein the weight/weight ratio between starch and the glassy carbohydrate material is from 0 to 0.5, preferably from 0 to 0.4, more preferably from 0 to 0.3, more preferably from 0 to 0.29, even more preferably from 0 to 0.27.

The present invention also provides compositions for making bouillons, comprising by weight of the total composition:
a) to f) according to either of the two compositions above or the composition in the process above whereby
g) 0.01 to 0.65 wt % of Na+, more preferably 0.01 to 0.5 wt % of Na+;
and wherein the weight/weight ratio between starch and the glassy carbohydrate material is from 0 to 0.5, preferably from 0 to 0.4.

The present invention also provides compositions for making bouillons, comprising by weight of the total composition:
a) to f) according to either of the two compositions above or the composition in the process above whereby
g) 0.01 to 0.4 wt % of Na+, more preferably 0.01 to 0.3 wt % of Na+;
and wherein the weight/weight ratio between starch and the glassy carbohydrate material is from 0 to 0.3, more preferably from 0 to 0.29.

The present invention also provides compositions for making bouillons, comprising by weight of the total composition:
a) to f) according to either of the two compositions above or the composition in the process above whereby
g) 0 to 0.25 wt % of Na+, more preferably 0.01 to 0.25 wt % of Na+;
and wherein the weight/weight ratio between starch and the glassy carbohydrate material is from 0 to 0.4, more preferably from 0 to 0.3.

The invention also provides a composition comprising, by weight of the total composition,
a) 0 to 1 wt % of vegetable oil;
b) 5 to 10 wt % of sucrose;
c) 1 to 30 wt % of herbs, spices and vegetables;
d) 0 to 10 wt % of native ungelatinised starch;
e) 30 to 40 wt % of dry glucose syrup having a DE value ranging from 26 to 30 and having a Dv30 of from 75-150 micrometer, polydextrose having a Dv30 of from 70-400 micrometer and combinations thereof;
f) 20 to 30 wt % of shea fat;
g) 0.01 to 0.5 wt % Na+
   and wherein the weight/weight ratio between starch and the dry glucose syrup and or polydextrose is from 0 to 0.4, more preferably from 0 to 0.3;
   and
   wherein the composition is in the form of a pasty bouillon tablet of 8 to 12 gram.

The invention also provides a composition comprising, by weight of the total composition,
a) 0 to 1 wt % of vegetable oil;
b) 5 to 10 wt % of sucrose;
c) 1 to 30 wt % of herbs, spices and vegetables;
d) 0 to 10 wt % of native ungelatinised starch;
e) 30 to 40 wt % of dry glucose syrup having a DE value ranging from 26 to 30 and having a Dv30 of from 75-150 micrometer, polydextrose having a Dv30 of from 70-400 micrometer, maltodextrin having maltodextrin with DE value ranging from 8 to 18 and combinations thereof;
f) 20 to 30 wt % of palm fat;
g) 0.01 to 0.5 wt % Na+
   and wherein the weight/weight ratio between starch and the dry glucose syrup, maltodextrin and or polydextrose is from 0 to 0.4, more preferably from 0 to 0.3;
   and
   wherein the composition is in the form of a pasty bouillon tablet of 8 to 12 gram.

### DETAILED DESCRIPTION OF THE INVENTION

The term “composition for making a bouillon” as used herein refers to the composition of e.g. a bouillon tablet, which provides a ready-to-eat bouillon after the dilution it was designed for e.g. a 10 g tablet is usually designed to be mixed with 500 g hot water, a dilution or mixing ratio of 50. The term “composition for making a bouillon” is interchangeably used with the term “composition for making a ready-to-eat bouillon” and “the composition according to the invention”.

The term “bouillon tablet” as used herein refers to bouillon tablets and bouillon cubes and is not limited to a specific geometric shape. It is a solid shape of at least 2 g, preferably of a pasty bouillon composition. In Europe, bouillon tablets can be more than about 21 g but are typically 7-12 gram and bouillon cubes are usually smaller e.g. 4 grams.

The term “ready-to-eat bouillon” as used herein refers to the aqueous bouillon obtained after mixing the composition according to the invention with sufficient aqueous phase such that flavouring is at the desired level for direct consumption. The product developer matches the concentration of ingredients in e.g. the bouillon tablet to the mixing ratio to be used.

The term “glassy carbohydrate material” as used herein refers to carbohydrate particles which have a non-crystalline (that is, amorphous) structure. Glass is a nonequilibrium, non-crystalline state of matter that appears solid on a short time scale but continuously relaxes towards the liquid state. Glassy carbohydrate material is usually formed from a melt by cooling to rigidity without crystallization.

### Composition for Making Bouillons

The composition according to the invention—like the iconic bouillon tablet composition which can be found in almost any kitchen cupboard—can be used to prepare a ready-to-eat bouillon. The primary aim is making a bouillon, but it also has secondary uses as described above. Typically, the bouillon composition according to the invention is formulated based on the specific dilution in the directions to use on the packaging. Usually the directions of use are one bouillon tablet of 7-12 grams is to be mixed with 500 g of hot water or dish such as a stew. In that case the dilution factor or mixing ratio (w/w) will be 500/12 to 500/7 corresponding 41.7 to 71.4. For a tablet of 10 g to be sold with the directions to use with 500 g water or dish the mixing ratio (w/w) is 50 (w/w). The product developer then starts with the desired end concentration in the ready-to-eat bouillon obtained after the prescribed dilution and calculates how much is needed in the bouillon tablet as starting concentration. In this example it would be 50 times higher in the bouillon tablet rendering the bouillon tablet obviously not “ready-to-eat”. Therefore, the bouillon tablet composition may also be referred to as a concentrate as it needs to be diluted e.g. 50 before it is palatable and ready for consumption. As described above standard bouillon cubes contain about 5 gram of NaCl in a 10 gram bouillon tablet to provide—after mixing with 500 gram hot water—a ready-to-eat bouillon having 0.5 g NaCl/100 g of ready-to-eat product. The bouillon tablet can have any desired flavour for example beef, chicken, pork, fish, mushroom, sea-food, vegetable, tom kha, kim-chi, specific herb combinations like thyme and rosemary, etc.

Preferably, the composition according to the invention provides a ready-to-eat bouillon after mixing the composition with a hot aqueous phase in a w/w ratio of 30 to 125, preferably whereby the aqueous phase is water. If the hot aqueous phase is a dish then the result is a ready-to-eat product. Preferably the mixing ratio is from 30 to 125, more preferably 30 to 75, more preferably 40 to 75, i.e. 1 g of bouillon tablet to be mixed with respectively 30 to 125 g, to 75 g, and 40 to 75 g of aqueous phase. Preferably, the composition according to the invention is a bouillon tablet of 2 to 30 g, more preferably 4 to 25 gram, even more preferably 7 to 12 gram, even more preferably 8 to 10 gram. Preferably the composition according to the invention is a pasty bouillon tablet of 2 to 30 g, more preferably 4 to 25 gram, even more preferably 7 to 12 gram, even more preferably 8 to 10 gram.

### Sodium Content (Na+)

The Na⁺ content of the composition according to the invention is preferably at most 0.75 wt % by weight of the total composition. A skilled person in the art of bouillon tablets designs the composition of the bouillon tablet to obtain a liquid bouillon after dispersing the bouillon tablet with a prescribed amount of water. Typically, bouillon tablets of 10 grams are formulated to result in 500 ml of ready-to-eat bouillon, i.e. a mixing ratio (w/w) of 50. For a tablet of 8 gram, the mixing ratio (w/w) is 500/8. Preferably the Na+ content in the composition according to the invention is such that said composition contributes 0 to 5 mg Na+/100 g to the ready-to-eat bouillon. During preparation of the composition according to the invention, preferably no kitchen salt (NaCl) is added to the composition according to the invention. However, Na⁺ may be present in minor amounts in the composition, as it may be present as part of a salt in any of the compounds which are added to the composition or be present in trace amounts in other ingredients. Nevertheless, the content of Na⁺ preferably is as low as possible.

Therefore, preferably the Na⁺ content of the composition according to the invention is from 0 to 0.75 wt %, more preferably from 0.001 to 0.75 wt %, even more preferably from 0.01 to 0.75 wt %, even more preferably from 0 to 0.70 wt % even more preferably from 0.001 to 0.7 wt %, even more preferably from 0.01 to 0.70 wt %, even more preferably from 0 to 0.65 wt % even more preferably from 0.001 to 0.65 wt % even more preferably from 0.01 to 0.65 wt %, even more preferably from 0 to 0.6 wt % even more preferably from 0.001 to 0.6 wt %, even more preferably from 0.01 to 0.6 wt %, even more preferably from 0 to 0.5 wt % even more preferably from 0.001 to 0.5 wt %, even more preferably from 0.01 to 0.5 wt %, even more preferably from 0 to 0.4 wt %, even more preferably from 0.001 to 0.4 wt %, even more preferably from 0.01 to 0.4 wt %, even more preferably from 0 to 0.3 wt %, even more preferably from 0.001 to 0.3 wt %, even more preferably from 0.01 to 0.3 wt %, even more preferably from 0 to 0.25 wt %, even more preferably from 0.001 to 0.25 wt % even more preferably from 0.01 to 0.25 wt %, even more preferably from 0 to 0.20 wt %, even more preferably from 0.001 to 0.20 wt % even more preferably from 0.01 to 0.20 wt %.

### Glassy Carbohydrate Material

The composition according to the invention preferably comprises glassy carbohydrate material. Typical carbohydrates used for glassy carbohydrate material include carbohydrates having a dextrose equivalent (DE) of 3 or higher, preferably having a DE of 3-30. Preferably DE of 3 to 7 and a DE of 26 to 30. Especially preferred examples include glassy carbohydrate material like maltodextrin, dry glucose syrup and polydextrose. The glassy carbohydrate material preferably contains 0 to 20 wt % of fat by weight of the glassy carbohydrate material, preferably 0 wt % of fat.

One method to produce glassy carbohydrate material is spray drying of e.g. maltodextrin. This typically results in hollow spheres characterised by parallel curved surfaces, i.e. the inner and outer surface of the shell defining the hollow sphere.

Another method is rapidly cooling the carbohydrate material to form a sheet of glassy carbohydrate and breaking the sheet into shards of carbohydrate material. The term “shards” as used herein refers solid particles characterised by an angular appearance similar to shards of broken glass and the absence of parallel curved surfaces. Shards preferably have an aspect ratio (longest dimension divided by the shortest dimension) of less than 5.

The composition according to the invention preferably comprises from 15 to 50 wt % of glassy carbohydrate material more preferably from 20 to 50 wt %, even more preferably from 20 to 45 wt %, even more preferably from 25 to 42 wt %. even more preferably from 28 to 40 wt %. even more preferably from 30 to 40 wt % by weight of the total composition. Preferably the composition according to the invention comprises glassy carbohydrate material including maltodextrin, dry glucose syrup, polydextrose in these ranges.

Preferably the composition according to the invention comprises glassy carbohydrate material in these ranges whereby the glassy carbohydrate material is in the form of hollow spheres.

It was surprisingly found that even better results including line efficiency and dissolution could be obtained when using glassy carbohydrate material having a certain size. The parameter Dv90 signifies the point in the size distribution, up to and including which, 90% of the total number of particles in the sample is ‘contained’. For example, if the Dv90 is 120 micrometer, this means that 90% number of particles in the sample has a size of 120 micrometer or smaller. The definition for Dv30 is the size point below which 30% of the total number of particles is contained. Similarly, the Dv10 is that size below which 10% of the total number of particles is contained. The term “Dv10” is understood to mean the specific size in the size distribution where 10% of the particles are smaller than this number. Dv values can be determined by using a Malvern particle sizer in powder-mode, where the powder is dispersed through the laser-beam of the Malvern. The particle size distribution is then calculated using the principles of light diffraction

Preferably, the composition according to the invention comprises an amount of glassy carbohydrate material in the ranges mentioned above, having a Dv30 of from 40 to 600 micrometer, more preferably of from 45 to 500 micrometer, even more preferably of from 50 to 400 micrometer, even more preferably of from 70 to 600 micrometer, even more preferably of from 70 to 500 micrometer, even more preferably of from 70 to 400 micrometer, from 70 to 300 micrometer, even more preferably of from 75 to 200 micrometer, preferably of from 75 to 150 micrometer; and preferably a Dv90 of from 200 to 1000 micrometer, more preferably 250 to 800 micrometer, even more preferably of from 300 to 700 micrometer, preferably whereby the glassy carbohydrate material is in the form of shards having these sizes.

Although the applicants do not wish to be bound by theory is it believed that if the glassy carbohydrate material is in the form of shards, the sharp edges of the shards are even more effective in improving the line efficiency than other forms of glassy carbohydrate material.

### Dry Glucose Syrup, Maltodextrin, Polydextrose

The composition according to the invention preferably comprises dry glucose syrup, maltodextrin, polydextrose and combination thereof, preferably in the range from 15 to 50 wt % of glassy carbohydrate material more preferably from 20 to 50 wt %, even more preferably from 20 to 45 wt %, even more preferably from 25 to 42 wt %. even more preferably from 28 to 40 wt %. even more preferably from 30 to 40 wt % by weight of the total composition.

Dry glucose syrup preferably originates from corn or maize or wheat. The glucose syrup is dried, in order to prevent that the composition of the invention contains too much water. In spite that the glucose syrup has been dried, it is still mentioned glucose ‘syrup’ in the art. The maltodextrin preferably also originates from corn or maize or wheat.

Polydextrose is a synthetic and partially metabolizable water-soluble polymer which primarily consists of D-glucose. Polydextrose is highly branched and contains α- and β-1-2, 1-3, 1-4 and 1-6 linkages, with the 1-6 linkage predominating in the polymer. Polydextrose is a soluble non-digestible carbohydrate that is partially fermented in the colon.

Preferably, the content of maltodextrin ranges from 15 to 50 wt % more preferably from 20 to 50 wt %, even more preferably from 20 to 45 wt %, even more preferably from 25 to 42 wt %. even more preferably from 28 to 40 wt %. even more preferably from 30 to 40 wt % by weight of the total composition.

Preferably, the dry glucose syrup has a DE value ranging from 26 to 30. Preferably, the maltodextrin has a DE value ranging from 8 to 20, preferably from 8 to 18, and most preferred from 9 to 17. Preferably, polydextrose has a DE value from 4 to 7. The DE value is the dextrose equivalent value which is the measure for the average length of glucose chains that make up maltodextrin and dry glucose syrup.

Preferably the dry glucose syrup, maltodextrin and/or polydextrose have a Dv30 of from 40 to 600 micrometer, more preferably of from 45 to 500 micrometer, even more preferably of from 50 to 400 micrometer, even more preferably of from 70 to 600 micrometer, even more preferably of from 70 to 500 micrometer, even more preferably of from 70 to 400 micrometer, from 70 to 300 micrometer, even more preferably of from 75 to 200 micrometer, preferably of from 75 to 150 micrometer; and preferably a Dv90 of from 200 to 1000 micrometer, more preferably 250 to 800 micrometer, even more preferably of from 300 to 700 micrometer.

Maltodextrin preferably has a Dv30 of from 40 to 600 micrometer, more preferably of from 45 to 500 micrometer, even more preferably of from 50 to 400 micrometer, even more preferably 50 to 300 micrometer, preferably 50 to 200 micrometer, preferably of from 50 to 100 micrometer, more preferably of from 50 to 80 micrometer; and preferably a Dv90 of from 200 to 1000 micrometer, more preferably 250 to 800 micrometer, even more preferably of from 300 to 700 micrometer.

Preferably the dry glucose syrup, polydextrose and combinations thereof, preferably in the form of shards, have a Dv30 of from 70 to 600 micrometer, more preferably of from 70 to 500 micrometer, even more preferably of from 70 to 400 micrometer. Other preferred Dv30 ranges include of from 70 to 300 micrometer, even more preferably of from 75 to 200 micrometer, preferably of from 75 to 150 micrometer, preferably a Dv90 of from 200 to 1000 micrometer, preferably of from 250 to 800 micrometer, preferably of from 300 to 700 micrometer.

Surprisingly it was found that with a certain weight/weight ratio between starch and the glassy carbohydrate material on the other, at least one of the advantages could be obtained e.g. like an improved line efficiency, improved dissolution. Preferably said ratio is from 0 to 0.6, more preferably from 0 to 0.5, preferably from 0 to 0.4, more preferably from 0 to 0.3, more preferably from 0 to 0.29, even more preferably from 0 to 0.27.

### Vegetable Oil

The composition may contain vegetable oil. With vegetable oil is meant an edible oil which is liquid at room temperature (between 2° and 25° C.). Preferably such vegetable oil has a solid fat content at 20° C. (N20) of smaller than 0.5%, preferably the N20 is 0. Preferably the vegetable oil comprises sunflower oil, rapeseed oil, soybean oil, linseed oil, olive oil, or combinations thereof. Alternative vegetable oils which are regularly used in food products, are suitable as well. If oil is used it must be used in amounts which do not result in the bouillon mass to become too sticky for processing. Preferably the content of vegetable oil ranges from 0 to 10 wt %, preferably 0 to 6 wt %, more preferred from 0 to 5 wt %, more preferably 0 to 2 wt % of vegetable oil, more preferably 0 to 1 wt % of vegetable oil by weight of the total composition. It may also be preferred that no vegetable oil is present.

Mono- and/or Disaccharides

Preferably the composition according to the invention comprises 0 to 25 wt % of crystalline ingredients like salt, monosodium glutamate, sugar or citric acid anhydrous or a combination thereof. The composition contains 0 to 25 wt % of crystalline mono- and/or disaccharides.

Preferably the content of crystalline mono- and/or disaccharides ranges from 1 to 20 wt %, preferably from 2 to 15 wt %, more preferably from 4 to 10 wt %. A preferred disaccharide to be added is crystalline sucrose, regular table sugar. In case crystalline sucrose is used, the sucrose crystals preferably have a diameter ranging from 0.1 and 0.75 millimeter. Preferably the composition according to the invention is substantially free of psicose.

If mono- and/or disaccharides are used, preferably the sum of
the total content of glassy carbohydrate material, preferably including dry glucose syrup, maltodextrin, polydextrose and combinations thereof, preferably in the form of shards; and
the mono- and/or disaccharides
   is of from 30 to 80 wt %, more preferably of from 35 to 75 wt %, even more preferably of from 40 to 70 wt % by weight of the total composition.

If mono- and/or disaccharides are used, preferably the sum of
the total content of dry glucose syrup, preferably in the form of shards; and
the mono- and/or disaccharides
   is of from 30 to 80 wt %, more preferably of from 35 to 75 wt %, even more preferably of from to 70 wt % by weight of the total composition.

If mono- and/or disaccharides are used, preferably the sum of
the total content of polydextrose, preferably in the form of shards; and
the mono- and/or disaccharides
   is of from 30 to 80 wt %, more preferably of from 35 to 75 wt %, even more preferably of from to 70 wt % by weight of the total composition.

### Flavouring Agents

The composition according to the invention preferably contains flavouring agent, preferably in a range from 0.05 to 20 wt %, preferably from 0.1 to 15 wt %, preferably from 1 to 12 wt %, or even 1 to 10 wt % of the total composition The terms “flavouring agent” and “flavouring agents” are used interchangeably whereby it understood that the singular refers to the plural and vice versa. The type of flavouring agent will depend on the desired flavour profile.

Preferably the flavouring agent includes beef flavour, chicken flavour, meat flavour, fish flavour, sea food flavour, pork flavour, spice flavour, vegetable flavour and combinations thereof. The term ‘flavouring agent’ should be understood to encompass a wide range of compositions or compounds that can be used as flavour.

Preferably the composition according to the invention additionally comprises flavouring agents including nucleotides, glutamic acid, or combinations thereof. In the context of this invention, glutamic acid comprises its salt, glutamate. Nevertheless, preferably the content of monosodium glutamate is maximally 1%, preferably maximally 0.5%, more preferably monosodium glutamate is absent. Most preferably monosodium glutamate is absent from the composition. If present, monosodium glutamate is preferably not added as a separate ingredient to the composition. For instance, yeast extract may be used as an ingredient in the composition, and this may contain nucleotides and monosodium glutamate. This may be used as long as the amount of sodium in the composition is less than described above.

### Herbs, Spices, Vegetables

Additionally, the composition according to the invention preferably further comprises 0.5 to 30 wt %, preferably 1 to 30 wt % of herbs, spices, vegetables, and mixtures thereof. Any herbs, spices, and vegetables commonly found in bouillons and soups can be used, e.g. parsley, pepper, etc. Preferably the herbs, spices, and vegetables comprise dried herbs, spices, and vegetables, like pieces of dried carrot, dried onion, dried garlic, dried leek. Preferably, vegetables may be in the form of vegetable powders.

### Starch

The composition according to the invention preferably comprises 0 to 30 wt %, more preferably 0 to 15 wt %, more preferably 0 to 10 wt %, more preferably 0 to 5 wt % of native ungelatinised starch by weight of the total composition. Native means that the starch is extracted from its source material and is subsequently purified to be used as food ingredient.

Preferably the native ungelatinised starch originates from corn, potato, wheat, rice, or tapioca. Most preferred the starch comprises corn starch, tapioca starch, potato starch and combinations thereof. It may also be preferred that starch is absent.

### Fat

The composition according to the invention preferably comprises 5 to 40 wt % of fat, more preferably 10 to 40 wt %, more preferably 20 to 35 wt %, more preferably 22 to 30 wt % by weight of the total composition. With fat is meant an edible fat which is solid at room temperature (between 2° and 25° C.). Preferably, the fat has a slip melting point (SMP) of at least 30° C. and preferably a solid fat content at 30° C. (N30) of at least 20%. Preferably the SMP is from 30 to 40° C. Preferably such fat has a solid fat content at 20° C. (N20) of at least 25%, more preferably at least 30%, even more preferably at least 35%. Preferably the fat has a solid fat content at 30° C. (N30) of at least 20%, more preferably at least 25%. Preferably, the fat has an N40 of below 10% and a SMP below 40° C.

Preferred fats include shea fat, allanblackia fat, sal fat, palm fat and mixtures thereof. Preferably the fat comprises palm oil, palm kernel, fractionated palm oil, palm stearin, palm olein, fully hydrogenated palm oil, shea fat, and combinations thereof.

The term “shea fat” as used herein is meant to include all forms of shea such as butter, olein, stearin and interesterified forms thereof and combinations thereof as long as the fat has a slip melting point (SMP) of at least 30° C. and preferably a solid fat content at 30° C. (N30) of at least 20%. Alternative edible fats which are regularly used in food products, are suitable as well, as long as the N20 requirement has been met. Suitably fats like coconut fat, cacao butter, hardened fats, tallow, chicken fat, or cow's milk fat may be used. The composition according to the invention preferably comprises 10 to 40 wt % of shea fat, preferably 20 to 35 wt %, more preferably 22 to 30% by weight of the total composition. If shea fat is used it is preferably added to the mixture as a solid fat. Regarding pasty bouillon tablets, surprisingly it has been found that if the shea fat is melted and added as a liquid this leads to an undesirable hardness of such bouillon tablets. If the bouillon composition according to the invention is a pasty bouillon tablets preferably these have a hardness of 5 to 40 Newton, more preferably 10 to 30 Newton, even more preferably of 14 to 25 Newton.

### Hardness Measurement of Tablet

Hardness measurement may be carried out using Texture Analyser (Stable Micro System, UK) equipped with 250 kg load cell and P/75 compression plate. Texture Analyser test mode set to “Compression” with pre-test speed of 1 mm/s, test speed of 0.5 mm/s, post-test speed of 10 mm/s, target mode of “Distance”, distance of 4 mm, halt time set to “No”, way back of 10 mm, trigger type to “Auto(Force), and trigger force of 50 gram. The tablet is measured from top to bottom, i.e. in the same direction in which the tablet was formed/compressed. Hardness is measured 24 hrs after production and stored at 30% relative humidity and 25° C., unless indicated otherwise.

Particularly preferred compositions of the invention comprise:
a) 25 to 50 wt % of polydextrose having a DE of 3 to 7; and
b) 20 to 35 wt % of shea fat preferably having a slip melting point (SMP) of at least 30° C. and preferably a solid fat content at 30° C. (N30) of at least 20%, or combinations thereof.

Particularly preferred compositions of the invention comprise:
a) 25 to 50 wt % of dry glucose syrup having a DE of 26 to 30; and
b) 20 to 35 wt % of shea fat preferably having a slip melting point (SMP) of at least 30° C. and preferably a solid fat content at 30° C. (N30) of at least 20%, or combinations thereof.

Particularly preferred compositions of the invention comprise:
a) 25 to 50 wt % of maltodextrin having DE of 9 to 17; and
b) 20 to 35 wt % of palm oil or palm oil stearin or fully hydrogenated palm oil, or combinations thereof.

More preferred, in combination with palm oil or palm oil stearin or fully hydrogenated palm oil, or combinations thereof, the content of maltodextrin ranges 28 to 40 wt %. even more preferably from 30 to 40 wt % by weight of the total composition Preferably, the maltodextrin has a DE value ranging from 3 to 20, preferably from 8 to 18, and most preferred from 9 to 17.

Preferably the content of palm oil or palm oil stearin, or combinations thereof ranges from 20 to 30 wt %, preferably from 25 to 30 wt %. In this case preferably the content of vegetable oil ranges from 1 to 10 wt %, preferably 1 to 6 wt %, more preferred from 2 to 5 wt %.

Particularly preferred compositions of the invention comprise:
a) 25 to 50 wt % of polydextrose having a DE of 3 to 7; and
b) 20 to 35 wt % of palm oil or palm oil stearin or fully hydrogenated palm oil, or combinations thereof.

Particularly preferred compositions of the invention comprise:
a) 25 to 50 wt % of dry glucose syrup having a DE of 26 to 30; and
b) 20 to 35 wt % of palm oil or palm oil stearin or fully hydrogenated palm oil, or combinations thereof.

### Free Water

The free water content in the composition according to the invention is preferably as low as possible. Preferably the free water content is maximally 1.5 wt %, preferably maximally 1%, more preferably free water is absent. In the context of the present invention, free water means unbound water, which may be added as such during the preparation of the composition. Nevertheless, the compounds which are used to prepare the composition may contain a certain amount of water, which is bound within the particles of the particulate composition. This is not considered to be free water. Such bound water being naturally present in the compounds, means that moisture may be present in the composition of the invention. Such moisture is not considered to be free water, in the context of the present invention. Notably the native starch may contain moisture. The water activity of the composition preferably ranges from 0.2 to 0.4. The low free water level leads to a composition that can be prepared in regular machinery used for preparation of bouillon tablets.

The resulting composition preferably has the appearance of a paste. Alternatively, and more preferred the composition is present in a compressed form, as a bouillon tablet. Therefore, preferably the composition is in the form of a bouillon tablet. Such bouillon tablet, preferably a pasty bouillon tablet suitably has a weight 2 to 30 g, more preferably 4 to 25 gram, even more preferably 7 to 12 gram, even more preferably 8 to 10 gram, which would be suitable to to be mixed with 500 g hot water to provide a ready-to-eat bouillon.

The savoury concentrate may suitably contain additional ingredients, such as taste enhancers (yeast extract, yeast autolysate, hydrolysed vegetable protein), gelatine, binders, emulsifiers (e.g. lecithin and/or monoglycerides), colouring (e.g. caramel, turmeric), minerals, vitamins, meat or vegetable extracts, vegetable powders and meat powder.

Preferably the composition according to the invention is composition whereby
the fat is shea fat, palm fat or mixtures thereof and
the glassy carbohydrate material is dry glucose syrup DE value ranging from 26 to 30 and/or polydextrose having a DE value ranging from 4 to 7, said glassy carbohydrate material
   being present in a range of 28 to 40 wt %;
   having a Dv30 of from 70 to 500 micrometer; and a Dv90 of from 250 to 800 micrometer;
   preferably in the form of shards of glassy carbohydrate material.

Preferably the composition according to the invention is composition whereby
the fat is palm fat and
the glassy carbohydrate material is selected from maltodextrin with DE value ranging from 8 to 18, dry glucose syrup DE value ranging from 26 to 30, polydextrose having a DE value ranging from 4 to 7 and combinations thereof, said glassy carbohydrate material
   being present in a range of 28 to 40 wt %;
   having a Dv30 of from 50 to 100 micrometer.

### Method for Preparation

The invention also provides a method for preparation of a composition according to the invention, comprising the steps of:
a) Mixing 50-100% of the ingredients of the composition according to the invention except for the fat
b) Admixing the fat, preferably in the form of solid fat e.g. in solid form (block or spagetthi, prills or flakes can be considered) preferably to obtain a pasty composition.
c) Optionally admixing the remainder of the ingredients, preferably this includes ingredients which are relatively sensitive to mixing like herbs and vegetables
d) Dosing the composition into portions, preferably in portions of 2-30 gram per portion, preferably into a cavity to form a bouillon tablet, if the composition is a pasty composition, preferably on a packaging material, preferably by extruding the pasty composition through a nozzle which remains open between consecutive dosages, preferably whereby said packaging material containing the mixture is subsequently formed into the desired shape by folding the packaging material and therewith also compressing the composition into a tablet, preferably a pasty bouillon tablet.

In the first step 50-100% of the ingredients, except the fat is mixed. Some ingredient like herbs and vegetables, in particular pieces thereof like parsley and carrot, may be mixed after the fat has been mixed. The method for preparation of the composition uses equipment normally suitable to make this kind of food composition, e.g. Ploughshare or Amixon or Z-blade type mixers, bouillon tablet production equipment from Corazza and BenHill

Subsequently, the fat is admixed. Preferably, the fat is in solid form such a flakes, sprinkles, prills, spaghetti like strands or block. If the fat is used in solid form it is heated to 20-30° C. before addition, preferably towards a fat solids content of 30%. If shea fat is used it is preferably mixed in the form of a solid block of 5-30 kg which preferably has been heated to about 25° C. Alternatively, shea fat can be added in a partly crystallised liquid form (typically obtained from a votator), or in liquid form.

Alternatively, if palm fat is used the fat may have been heated in order to liquify the fat. The temperature to heat such fat is commonly known for regular fats. In case the fat is liquid, it can be used to bind the dry powders, and create a more pasty mix, which subsequently partly solidifies into a paste. Preferably if palm fat is used, the palm fat is not added completely liquid but cooled several degrees below the melting point of the fat in order to pre-crystallise the fat. The melting point may be between 5 and 20° C. depending on the fat composition. The solid fat content of such mixture has been increased compared to the fully liquid fat. Nevertheless, the fat in such case is still in liquid form (although a bit more viscous) and can be used to create a paste with the powdered mixture. Such cooling can be done in a controlled manner in a regular votator. The advantage of using such partly pre-crystallised fat, is that a structure of solid fat crystals is created which keeps other ingredients together, and that can also retain liquid vegetable oil.

After the fat has been admixed, optionally other ingredients may be admixed if these have not been added in the first step. Preferably, this includes ingredients like herbs and vegetables, in particular pieces thereof like parsley and carrot which may be damaged by extensive mixing.

Before the step of dosing the mixture may be allowed to mature to reach the right condition for dosing, preferably for 10 min to 24 hrs.

The composition according to the invention is dosed into portions, preferably into portions of 2-30 gram, preferably of 2 to 30 g, more preferably 4 to 25 gram, even more preferably 7 to 12 gram, even more preferably 8 to 10 gram is dosed per portion. Preferably, the composition is dosed into a cavity of the desired shape to form the bouillon tablet.

Preferably, the mixture obtained before dosing is a pasty composition also referred to as a pasty bouillon mass composition. The term “pasty composition” or “pasty bouillon mass composition” is understood to refer a non-free flowing plastic deformable mass which is shape retaining for at least 2 minutes at 25° C., e.g. similar to a firm dough. If the composition is pasty bouillon mass composition, preferably the step of dosing comprises extruding the pasty bouillon mass composition through a nozzle. Usually between 2-30 gram is dosed per portion, preferably of 2 to 30 g, more preferably 4 to 25 gram, even more preferably 7 to 12 gram, even more preferably 8 to 10 gram is dosed per portion. The nozzle is preferably an open nozzle, i.e. the nozzle remains open between consecutive dosages and the dosages are measured by a cutting wire. The nozzle opening preferably has a diameter of from 0.5 to 2 cm, preferably 0.8 to 1.5 cm.

Preferably, the composition is dosed into a cavity of the desired shape to form the bouillon tablet. Preferably, the composition is dosed on a foldable wrapper, like aluminium or laminated paper. Preferably, the cavity is lined with a foldable wrapper. Such packaging material containing the mixture is subsequently formed into the right shape by folding the packaging material and therewith also compressing the composition into a tablet, preferably a pasty bouillon tablet. The packaging materials suitably contains paper or aluminium which may be coated.

As indicated before, preferably the free water content is lower than 1.5%, or more preferred the composition contains no free water. Therefore, preferably no water as such is added in any of the processing steps to prepare the composition according to the invention.

As also indicated before, the Na⁺ content of the composition is low. Therefore, or if NaCl and/or MSG are added the amount of Na+ may not exceed the ranges mentioned above, preferably no sodium chloride and/or MSG as such is added to prepare the composition according to the invention.

The invention further provides a method for preparation of a composition for making bouillons according to the invention, comprising the steps of:
i. Mixing 50-100% of the ingredients of the composition except for the fat;
ii. Admixing the fat, preferably in the form of solid fat;
iii. Optionally admixing the remainder of the ingredients if any
iv. Dosing the composition into portions, preferably in portions of 2-30 gram per portion.

Said composition comprising by weight of the total composition:
a) 0 to 1 wt % of vegetable oil;
b) 5 to 10 wt % of sucrose;
c) 1 to 30 wt % of herbs, spices and vegetables;
d) 0 to 10 wt % of native ungelatinised starch;
e) 30 to 40 wt % of dry glucose syrup having a DE value ranging from 26 to 30 and having a Dv30 of from 75-150 micrometer, polydextrose having a Dv30 of from 70-400 micrometer, maltodextrin having maltodextrin with DE value ranging from 8 to 18 and combinations thereof;
f) 20 to 30 wt % of palm fat;
g) 0.01 to 0.5 wt % Na⁺
   and wherein the weight/weight ratio between starch and the dry glucose syrup, maltodextrin and or polydextrose is from 0 to 0.4, more preferably from 0 to 0.3;
   and
   wherein the composition is in the form of a pasty bouillon tablet of 8 to 12 gram.

The invention also provides a method for preparation of a composition for making bouillons according to the invention, comprising the steps of:
i. Mixing 50-100% of the ingredients of the composition except for the fat;
ii. Admixing the fat, preferably in the form of solid fat;
iii. Optionally admixing the remainder of the ingredients if any
iv. Dosing the composition into portions, preferably in portions of 2-30 gram per portion.

Said composition comprising by weight of the total composition:
a) 0 to 1 wt % of vegetable oil;
b) 5 to 10 wt % of sucrose;
c) 1 to 30 wt % of herbs, spices and vegetables;
d) 0 to 10 wt % of native ungelatinised starch;
e) 30 to 40 wt % of dry glucose syrup having a DE value ranging from 26 to 30 and having a Dv30 of from 75-150 micrometer, polydextrose having a Dv30 of from 70-400 micrometer and combinations thereof;
f) 20 to 30 wt % of shea fat;
g) 0.01 to 0.5 wt % Na⁺
   and wherein the weight/weight ratio between starch and the dry glucose syrup and or polydextrose is from 0 to 0.4, more preferably from 0 to 0.3;
   and
   wherein the composition is in the form of a pasty bouillon tablet of 8 to 12 gram.

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Ratios are weight/weight, unless indicated otherwise.

Similarly, all percentages are weight/weight percentages by weight of the total composition unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps. The reference in this specification to any prior publication (or information derived from it), or to any matter which is known, is not, and should not be taken as an acknowledgement or admission or any form of suggestion that that prior publication (or information derived from it) or known matter forms part of the common general knowledge in the field of endeavour to which this specification relates.

The invention is further illustrated by the following non-limiting examples. It will be clear to the skilled person how to carry out the invention by using equivalent means without departing from the invention.

### EXAMPLES

The following compositions were prepared to create bouillon tablets, following the process of the invention. All ingredients were sourced in Europe and USA.

### Example 1—Improved Bouillon Tablet Compositions

TABLE 1
Compositions A to E according to the invention

| | | | C | | |
|---|---|---|---|---|---|
| | A (veg) | B (beef) | (chicken) | D | E |
| Ingredient | [weight %] | [weight %] | [weight %] | [weight %] | [weight %] |
| Herbs and spices | 3.9 | 3.0 | 3.5 | 3.8 | 3.8 |
| Veg powders (garlic onion | 9.6 | 9.6 | 8.8 | 9.9 | 9.6 |
| leek carrot) | | | | | |
| Flavouring agents | 9.9 | 12.6 | 9.7 | 10.6 | 10.6 |
| Sucrose (0.1 and 0.75 | 8.0 | 8.0 | 10.0 | 8.0 | 10.0 |
| millimeter. | | | | | |
| Native Potato Starch | 8.0 | 8.0 | 9.0 | 0.0 | 8.0 |
| Glassy carbohydrate | 35.6^{a} | 33.8^{a} | 35.0^{a} | 38.0^{a} | 34.0^{b} |
| material | | | | | |
| Shea butter | 25.0 | 22.0 | 24.0 | 29.7 | 24.0 |
| Animal fat | | 3.0 | | — | |
| Free water | 0 | 0 | 0 | 0 | 0 |
| Total | 100 | 100 | 100 | 100 | 100 |
| Ratio (w/w) of starch to | 0.22 | 0.24 | 0.26 | 0 | 0.24 |
| glassy carbohydrate | | | | | |
| Dissolution time (seconds) | 57 | 60 | 70 | NA | 36 |
| Line efficiency | 48% | 68% | 86% | 70% | 75% |

Glassy carbohydrate material^{a} = Dry Glucose Syrup (DE 28) (Dv30 = 85 micrometer)
Glassy carbohydrate material^{b} = Polydextrose (DE 4) (Dv30 = 102 micrometer) (Promitor ® ex Tate and Lyle)

The compositions were prepared according to the method of the invention. All dry powders, oil and animal fat were added to a vessel with a mixer and mixed for 1 minute at 60 rpm. Subsequently solid shea fat was added to the mixture and mixed for 3 minutes at 60 rpm. (When palm fat is used it was added in votated, liquid form) Parsley and other vegetable pieces were added and the mixing was extended for another minute at 60 RPM. The resulting pasty composition was extruded through an open nozzle on paper packaging material, and subsequently mechanically wrapped into single bouillon tablets. The tablets were pasty and had a weight of about 9 gram.

As can be seen Examples A to E had very good line efficiencies (up to 86%) compared to e.g. 15% using the comparative experiments i-IV of Example 2 below (see table 2). Compositions A to E all had less than 0.19 wt % of Na⁺. Ready-to-eat bouillons prepared using mixing ratio (w/w) of 500/9, a tablet of 9 gram was mixed with 500 g of hot water. The inventive compositions contribute less than than 5 mg Na⁺ to 100 g of ready-to-eat bouillon.

### Dissolution Test

Dissolution time was determined by mixing 1 tablet (7-12 gram) with 500 gram of boiling water, in a 600 ml glas-jar, which is being stirred at 120 RPM. The dissolution time is either defined by 90% of the final conductivity of the liquid bouillon, or by visual judgement of dissolution of all dissolvable tablet-constituents (so excluding pieces and other non-dissolvable material).

### Example 2—Comparative Bouillon Tablet Compositions

TABLE 2

| | Comparative | Comparative | Comparative | Comparative |
|---|---|---|---|---|
| Ingredient[weight %] | I | II | III | IV |
| Herbs and spices | 3.8 | 3.8 | 3.8 | 3.9 |
| Veg powders (garlic onion | 9.6 | 9.6 | 9.6 | 9.6 |
| leek carrot) | | | | |
| Flavouring agents | 10.6 | 10.6 | 10.6 | 9.9 |
| Sucrose | 8.0 | 8.0 | 8.0 | 8.0 |
| Native Potato Starch | 49.0 | 20.0 | 16.0 | 22.6 |
| Glassy carbohydrate | 0 | 20^{a} | 27^{a} | 24^{b} |
| material | | | | |
| Shea fat | 19.0 | 26.0 | 23.0 | 22.0 |
| Animal fat | — | 2.0 | 2.0 | — |
| Free water | 0 | 0 | 0 | 0 |
| Total | 100 | 100 | 100 | 100 |
| Ratio (w/w) of starch to | infinite | 1 | 0.6 | 0.9 |
| glassy carbohydrate | | | | |
| Line efficiency | 10% | 10% | 15% | 10% |

Glassy carbohydrate material^{a} = Dry Glucose Syrup (DE 28) (Dv30 = 85 micrometer)
Glassy carbohydrate material^{b} = Polydextrose (DE 4) (Dv30 = 102 micrometer) (Promitor ® ex Tate and Lyle)

### Example 3—Comparative Example with Water

TABLE 3
Comparative example 3 with water

| Ingredient | [weight %] |
|---|---|
| Tapioca starch native | 27.6 |
| Palm oil (80%) palm stearin (20%) | 27 |
| White sucrose | 10 |
| Glassy carbohydrate material | 26.8 |
| Soybean oil | 4 |
| Herbs, spices | 0.9 |
| Garlic, onion, leek dried, carrot | 1.3 |
| Flavouring agents | 0.6 |
| Water | 1.8 |

Glassy carbohydrate material^{d} = Maltodextrin (DE 10) (Dv30 = 60 micrometer)

Comparative Example 3 could not be made successfully. Due to the water, which was added to the recipe, the composition became too sticky, and could not be packaged into single pasty bouillon tablet.

### Example 4—Examples According to the Invention with Improved Dissolution

The compositions of table 4 were prepared as described for example 1. The dissolution was measured as described above. It clear that the examples according to the invention had improved dissolution compared to comparative example V with a ratio of starch to glassy carbohydrate of 1

TABLE 4

| | Comparative | | |
|---|---|---|---|
| | V | F | G |
| Ingredient | [weight %] | [weight %] | [weight %] |
| Corn starch native | 27 | 10 | 10 |
| Palm oil Stearine | 31 | 32 | 31 |
| White sucrose | 10 | 10 | 10 |
| Glassy carbohydrate material | 27^{d} | 43^{b} | 44^{c} |
| Herbs, spices | 1 | 1 | 1 |
| Garlic, onion, leek dried, carrot | 3 | 3 | 3 |
| Flavouring agents | 1 | 1 | 1 |
| Ratio (w/w) of starch to glassy carbohydrate | 1 | 0.23 | 0.23 |
| Dissolution time [sec] | 215 | 90 | 60 |

Glassy carbohydrate material^{b} = Polydextrose (DE 4) (Dv30 = 102 micrometer)
Glassy carbohydrate material^{c} = Polydextrose (DE 4) (Dv30 = 300 micrometer) fraction smaller than 250 micrometer removed by sieving
Glassy carbohydrate material^{d} = Maltodextrin (DE10) (Dv30 = 60 micrometer)

1. A composition for making bouillons, comprising by weight of the total composition:
a) 0 to 10 wt % of vegetable oil;
b) 0 to 25 wt % of crystalline mono- and/or disaccharides;
c) 0.5 to 30 wt % of herbs, spices and vegetables;
d) 0 to 30 wt %, preferably 0 to 15 wt % of native ungelatinised starch;
e) 15 to 50 wt % preferably 20 to 50 wt % of glassy carbohydrate material;
f) 5 to 40 wt % of fat, preferably 10 to 40 wt %, more preferably 20 to 35 wt %, even more preferably 22 to 30%;
g) 0 to 0.75 wt % of Na+;
and wherein the weight/weight ratio between starch and the glassy carbohydrate material is from 0 to 0.5, preferably from 0 to 0.4, more preferably from 0 to 0.3, more preferably from 0 to 0.29, even more preferably from 0 to 0.27.

2. The composition according to claim 1, wherein the composition provides a ready-to-eat bouillon after mixing with a hot aqueous phase in a w/w ratio of 30 to 125, whereby said composition contributes 0 to 5 mg Na+ to 100 g of the ready-to-eat bouillon.

3. The composition according to claim 1, wherein the Na+ content is from 0.001 to 0.75 wt %, even more preferably from 0 to 0.7 wt %, even more preferably from 0.001 to 0.7 wt %, even more preferably from 0 to 0.65 wt %, even more preferably from 0.001 to 0.65 wt %, even more preferably from 0 to 0.6 wt %, even more preferably from 0.001 to 0.6 wt %, even more preferably from 0 to 0.5 wt %, even more preferably from 0.001 to 0.5 wt %, even more preferably from 0 to 0.4 wt %, even more preferably from 0.001 to 0.4 wt %, even more preferably from 0 to 0.3 wt %, even more preferably from 0.001 to 0.3 wt %, even more preferably from 0 to 0.25 wt %, even more preferably from 0.001 to 0.25 wt %, even more preferably from 0.01 to 0.25 wt %, even more preferably from 0 to 0.2 wt %, even more preferably from 0.001 to 0.2 wt %, even more preferably from 0.01 to 0.2 wt %.

4. The composition according to claim 1, wherein the content of monosodium glutamate is 0 to 1 wt %, preferably 0 to 0.5 wt %, by weight of the total composition, more preferably wherein monosodium glutamate is absent.

5. The composition according to claim 1, wherein the glassy carbohydrate material has a Dv30 of from 40 to 600 micrometers and preferably a Dv90 of from 200 to 1000 micrometers, preferably whereby the glassy carbohydrate material is in the form of shards.

6. The composition according to claim 1, wherein the glassy carbohydrate material is selected from dry glucose syrup, maltodextrin, polydextrose and mixtures thereof; and the content of glassy carbohydrate material preferably ranges from 20 to 45 wt %, preferably from 25 to 42 wt %, even more preferably from 28 to 40 wt %, even more preferably from 30 to 40 wt % by weight of the total composition.

7. The composition according to claim 1, wherein
the fat is shea fat, palm fat or mixtures thereof, and
the glassy carbohydrate material is dry glucose syrup having a DE value ranging from 26 to 30 and/or polydextrose having a DE value ranging from 4 to 7, and
wherein said glassy carbohydrate material is
present in a range of 28 to 40 wt %; and has
a Dv30 of from 70 to 500 micrometers and a Dv90 of from 250 to 800 micrometers, preferably in the form of shards of glassy carbohydrate material.

8. A The composition according to claim 1, wherein
the fat is palm fat and
the glassy carbohydrate material is selected from maltodextrin with a DE value ranging from 8 to 18, dry glucose syrup having a DE value ranging from 26 to 30, polydextrose having a DE value ranging from 4 to 7, and combinations thereof, and
wherein said glassy carbohydrate material is
present in a range of 28 to 40 wt % and has
a Dv30 of from 50 to 100 micrometers.

9. The composition according to claim 1, comprising, by weight of the total composition,
a) 0 to 1 wt % of vegetable oil;
b) 5 to 10 wt % of sucrose;
c) 1 to 30 wt % of herbs, spices and vegetables;
d) 0 to 10 wt % of native ungelatinised starch;
e) 30 to 40 wt % of dry glucose syrup having a DE value ranging from 26 to 30, and having a Dv30 of from 75 to 150 micrometers, polydextrose having a Dv30 of from 70 to 400 micrometers, and combinations thereof;
f) 20 to 30 wt % of shea fat;
g) 0.01 to 0.5 wt % Na+, and
wherein the weight/weight ratio between starch and the dry glucose syrup and or polydextrose is from 0 to 0.4, more preferably from 0 to 0.3; and
wherein the composition is in the form of a pasty bouillon tablet of 8 to 12 gram.

10. The composition according to claim 1, comprising, by weight of the total composition,
a) 0 to 1 wt % of vegetable oil;
b) 5 to 10 wt % of sucrose;
c) 1 to 30 wt % of herbs, spices and vegetables;
d) 0 to 10 wt % of native ungelatinised starch;
e) 30 to 40 wt % of dry glucose syrup having a DE value ranging from 26 to 30, and having a Dv30 of from 75 to 150 to micrometers, polydextrose having a Dv30 of from 70 to 400 micrometers, maltodextrin having DE value ranging from 8 to 18, and combinations thereof;
f) 20 to 30 wt % of palm fat;
g) 0.01 to 0.5 wt % Na+, and
wherein the weight/weight ratio between starch and the dry glucose syrup, maltodextrin and or polydextrose is from 0 to 0.4, more preferably from 0 to 0.3; and
wherein the composition is in the form of a pasty bouillon tablet of 8 to 12 gram.

11. A method for preparation of the composition according to claim 1, the method comprising the steps of:
mixing 50-100% of the ingredients of the composition except for the fat;
admixing the fat, preferably in the form of solid fat;
optionally admixing the remainder of the ingredients, if any; and
dosing the composition into portions, preferably in portions of 2-30 gram per portion.

12. The method according to claim 11, wherein the fat is shea fat and is added as a block of solid fat having a temperature of 20 to 30° C.

13. The method according to claim 11, wherein the mixture obtained before dosing is a pasty composition.

14. The method according to claim 11, whereby the dosing comprises extruding the pasty bouillon mass composition through an open nozzle which remains open between consecutive dosages and the dosages are measured by a cutting wire.

15. A method for preparation of the composition according to claim 1, wherein no sodium chloride and/or MSG as such is added to prepare the composition.
